(19) United States
(12) Patent Application Publication
(10) Pub. No.: US 2014/0279358 A1
(43) Pub. Date: Sep. 18, 2014

(54) DYNAMIC INSTRUMENT LIMIT BOOK CREATION

(71) Applicants: Glenn Rosenberg, Westport, CT (US); David K. Smith, New York, NY (US)

(72) Inventors: Glenn Rosenberg, Westport, CT (US); David K. Smith, New York, NY (US)

(21) Appl. No.: 14/204,723

(22) Filed: Mar. 11, 2014

Related U.S. Application Data
(60) Provisional application No. 61/779,791, filed on Mar. 13, 2013.

(51) Int. Cl. G06Q 40/04

(52) U.S. Cl. CPC G06Q 40/04
USPC 705/37

(57) ABSTRACT

The example embodiments may relate to receiving a new market request that requests creation of a market for trading of a new financial instrument, wherein the request identifies an instrument type, quantity, and price, in response to the request, creating a financial instrument based on the instrument type, the quantity, and the price, creating a pricing model, a limit book, and a fill model for the created financial instrument, initializing and binding the created financial instrument, the limit book, the pricing model, and the fill model, and activating the limit book for price discovery and trading of the created financial instrument.

### CROSS REFERENCE TO RELATED APPLICATIONS

This application claims the benefit of, and priority to, U.S. Provisional Patent Application No. 61/779,791 titled “Dynamic Instrument Limit Book Creation,” filed Mar. 13, 2013. The content of which is hereby incorporated by reference in its entirety.

### BACKGROUND

1. Field

The invention relates to systems and methods for dynamic instrument limit book creation. Among other fields and applications, the invention has utility in trading of instruments in over the counter derivative markets.

2. Description of Related Art

The very nature of over the counter (OTC) markets is that they are bespoke. Securities can be customized and created in the moment to meet user needs. The customized nature of the OTC markets makes them very difficult to standardize. Consequently, OTC derivatives are not listed and not traded electronically in an exchange format. The OTC derivative market encompasses several asset classes, including but not limited to fixed income securities, unlisted equities, unlisted commodities and foreign exchange.

OTC trading workflows include standard pre-trade price discovery (Request-For-Quotes (RFQ), quotes, etc.), trading and trade execution (orders, fills, etc.), post trade management (confirmation reports, allocations, etc.), and others. Being bespoke markets, most workflows depend upon manual processes. For example, there are currently two practical means to trade the OTC foreign exchange options (FXO) market. One is simple voice communication, where trades are executed over the phone. The other is some basic manner of electronic trading via instant messaging or other electronic messaging protocols. Current OTC FXO electronic trading venues mirror the voice trading venues, where Request for Quote (RFQ) workflows provide the primary means for price discovery and trade execution. For RFQ workflows, someone looking for a market will “request” bids and/or offers from one or more market makers. Market makers will communicate their dealable prices and the person requesting the market can trade or not trade. After deciding to trade, both parties negotiate the final deal terms and prices before booking the trade. Whether voice or electronic, the negotiation process is manual. There are no OTC FXO electronic venues or exchanges that completely automate all bespoke OTC market workflows, including final trade negotiations, in an anonymous many-to-many exchange traded format.

### BRIEF SUMMARY

The example embodiment may relate to systems, methods, apparatuses, and computer readable media configured for receiving a new market request that requests creation of a market for trading of a new financial instrument, wherein the request identifies an instrument type, quantity, and price, in response to the request, creating a financial instrument based on the instrument type, the quantity, and the price, creating a pricing model, a limit book, and a fill model for the created financial instrument, initializing and binding the created financial instrument, the limit book, the pricing model, and the fill model, and activating the limit book for price discovery and trading of the created financial instrument.

Other systems, methods, features, and advantages of the present disclosure will be or will become apparent to one with skill in the art upon examination of the following figures and detailed description. All such additional systems, methods, features, and advantages are included within this description, are within the scope of the disclosure, and are protected by the accompanying claims. Accordingly, the present disclosure is not restricted except in light of the attached claims and their equivalents.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 illustrates a block diagram of a system for dynamic instrument limit book creation in accordance with example embodiments.

FIG. 2 illustrates a flow diagram for an automated “dual-mode” exchange for processing of market request models with dynamic instrument limit book creation.

FIG. 3 illustrates a flow diagram for posting a new market with dynamic instrument limit book creation in accordance with example embodiments.

FIG. 4 illustrates a flow diagram of a process for executing a trade request against a posted market with dynamic instrument limit book creation in accordance with example embodiments.

FIG. 5 illustrates a flow diagram of a process for requesting a new market with dynamic instrument limit book creation in accordance with example embodiments.

FIG. 6 illustrates a flow diagram of a process for dynamic instrument limit book creation in accordance with example embodiments.

FIGS. 7A, 7B, 7C, 7D, and 7E describe an example of posting a new market with dynamic instrument limit book creation in accordance with example embodiments of the present disclosure.

FIGS. 8A, 8B, 8C, 8D, 8E, 8F, and 8G describe an example of executing a trade request with dynamic instrument limit book creation in accordance with example embodiments of the present disclosure.

FIGS. 9A, 9B, 9C, 9D, and 9E describe an example of requesting a new market with dynamic instrument limit book creation in accordance with example embodiments of the present disclosure.

FIGS. 10A, 10B, 10C, 10D, 10E, 10F, and 10G describe an example of executing a generic trade request with dynamic instrument limit book creation in accordance with example embodiments of the present disclosure.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, or devices. Accordingly, the present invention may take the form of an entirely hardware embodiment, an entirely software embodiment, or an embodiment combining software and hardware aspects. The following detailed description is, therefore, not to be taken in a limiting sense.

FIG. 1 illustrates a block diagram of a system 100 for dynamic instrument limit book creation in accordance with example embodiments. System 100 may include one or more client terminals 102, one or more exchange servers 104, and one or more databases 106, connected via one or more networks 70. Networks 70 may be the Internet, WAN, LAN, Wi-Fi, other computer networks (now known or invented in the future), and/or any combination of the foregoing. It should be understood by those of ordinary skill in the art having the present specification and drawings before them that networks 70 may connect the various components over any combination of wired and wireless conduits, including copper, fiber optic, microwaves, and other forms of radio frequency, electrical and/or optical communication techniques. It should also be understood that any network 70 may be connected to any other network 70 in a different manner. The interconnections between devices in system 100 are examples. Any device depicted in FIG. 1 may communicate with any other device via one or more of the networks 70.

Exchange servers 104 may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. Exchange servers 104 may be running on any one of many operating systems including, but not limited to WINDOWS, UNIX, LINUX, MAC OS, or Windows (XP, VISTA, etc.). It is contemplated, however, that any suitable operating system may be used for the present invention. Exchange servers 104 may be a cluster of web servers, which may each be LINUX based and supported by a load balancer that decides which of the cluster of web servers should process a request based upon the current request-load of the available server(s). Exchange servers 104 may include hardware and/or software for executing supported workflows and processes, databases, redundancies, operational support, etc.

Client terminals 102A-D may be general purpose computers that may have, among other elements, a microprocessor (such as from the Intel Corporation or AMD); volatile and non-volatile memory; one or more mass storage devices (i.e., a hard drive); various user input devices, such as a mouse, a keyboard, or a microphone; and a video display system. Examples of terminals include tablets, mobile phones, smart phones (e.g., iPhone), computers, laptops, and the like. In one aspect, the general-purpose computer may be controlled by the WINDOWS XP operating system. It is contemplated, however, that the present system would work equally well using a Mac OS computer or even another operating system such as a WINDOWS VISTA, UNIX, or LINUX or a JAVA based operating system, to name a few.

Terminals 102A-D may operably connect to exchange servers 104, via one of many available internet browsers including, but not limited to, Microsoft's Internet Explorer, Apple's Safari, and Mozilla's Firefox. Via any of networks 70, end users may access the system 100 with an http-based website, although other graphical user interfaces can be used with the present system. In some examples, terminal 102A-D may use custom or standard message protocols (e.g., Financial Information exchange (FIX) protocol, e.g., FIX 4.4 Specification) for communicating with exchange servers 104. Information entered by an end user via terminals 102A-D may be encrypted before transmission over a network for additional security. There are several commercially available encryption programs or algorithms available including, but not limited to, PC1 Encryption Algorithm, Truecrypt, a Symantec encryption program, Blowfish, and Guardian Edge. Terminals 102A-D may also connect to exchange servers 104 via their own internal services and software applications or via software provided by other vendors.

System 100 may include additional devices and networks beyond those shown. Further, the functionality described as being performed by one device may be distributed and performed by two or more devices. Multiple devices shown in FIG. 1 may also be combined into a single device, which may perform the functionality of the combined devices. System 100 may dynamic instrument limit book creation from a variety of sources including those depicted in FIG. 1.

In some examples, exchange servers 104 may provide an automated “dual-mode” exchange delivering anonymous many-to-many price discovery and trading to the over the counter (OTC) Derivatives Market Place. OTC Derivatives Markets may be bespoke markets where new custom instruments are created as specified by deals executed between parties. Once created, instruments persist and are managed in the market place throughout their lifetimes. To accommodate the bespoke nature of the OTC Derivatives Markets in an electronic market place, exchange servers 104 may provide an automated process of dynamic instrument limit book creation, where instruments, limit books, validation models, execution models, market data, workflow processes, etc., may be created automatically on demand and made available for immediate price discovery, trading, and other supported workflows.

Several exchange activities can initiate dynamic instrument limit book creation including, but not limited to, attempts to post markets for previously unknown instruments, soliciting prices for previously unknown instruments, and direct requests for the creation of new markets. Newly created markets may be persisted and managed throughout the life of the associated instruments. Additionally, the dual nature of the OTC Derivatives Markets may initiate dynamic instrument limit book creation upon execution of a trade. In some example, OTC Derivatives Markets trade two different classes of instruments: (1) those specified in relative terms like tenor, delta, etc., and (2) those specified in specific terms like maturity, strike, etc. Both classes may be priced in volatility, rates, currencies, etc. Trade execution of a relatively specified instrument may create specified instruments as agreed upon by the parties, and trade execution of specifically specified instruments may create additional instruments as well. The “Dual Mode” of exchange servers 104 may support both classes, relative and specific, on an equal footing providing equivalent anonymous many-to-many price discovery, trading, and supported workflows, where new limit books are dynamically created, including those generated by trade execution. “Dual mode” may describe simultaneous support for real-time automated price discovery and trading of “relatively” specified markets and “specifically” specified markets. For example, but not limited to, option derivatives can be “relatively” specified in terms of tenor and risk (e.g., delta) or “specifically” specified in terms of maturity and strike.

FIG. 2 illustrates a flow diagram for an automated “dual-mode” exchange for processing of market requests with dynamic instrument limit book creation. The flow diagram may be implemented by a system or apparatus, such as, for example, exchange server 104. Each of the blocks shown in the flow diagram may be repeated one or more times, one or more of the blocks may be modified, and one or more of the blocks may be omitted. The flow diagram may be stored on a non-transitory computer readable medium as computer executable instructions. The computer executable instructions, when executed by at least one processor, may cause at least one computer or other device to perform the blocks as steps of a method one or more times. The flow diagram may begin at block 202.

In block 202, the exchange server 104 may receive a new market request. A new market request may initiate real-time dynamic instrument limit book creation in a variety of ways including, but not limited to, posting a market for a previously unknown instrument and via trading against a currently posted market where the execution process creates previously unknown instruments (e.g., creation of “specifically” specified markets when trading “relatively” specified markets). For example, the new market request may request creation of a market for trading of a new financial instrument, wherein the request identifies an instrument type, quantity, and price. In some examples, the new market request may include an identifier and data for each of a plurality of leg instruments. Example leg data may include one or more of a leg instrument type (e.g., spot, forward, delta option, barrier option, strike option, etc.), leg maturity, leg style, a leg side, a leg quantity, a leg price, or other desired information describing a suitable let instrument. Leg data examples are also shown in FIGS. 7A, 8A, and 9A.

In block 204, the exchange server 104 may accept the new market request and may determine, in block 206, whether the request is valid. If invalid, the exchange server may, in block 208, reject the request. If valid, the exchange server 104 may, in block 210, process the request. In block 212, the exchange server 104 may determine whether the request can be executed. If executable, the exchange server 104 may execute the request in block 214. An example of executing a trade request is later described in this application with reference to FIGS. 4, 8A-G, and 10A-G. If unexecutable, the exchange server 104 may, in block 216, determine whether the request can be posted. If postable, the exchange server 104 may, in block 218, post the request. To post a newly introduced market, exchange server 104 may create products and components to post the new market and begin real-time price discovery and trading. An example of posting a request is later described in this application with reference to FIGS. 3 and 7A-E.

If unpostable, exchange server 104 may determine, in block 220, whether the request corresponds to a new instrument limit book. If a new limit book is to be created, the exchange server 104 may, in block 222, request that a new limit book be created using dynamic instrument limit book creation. An example of requesting that a new limit book be created is later described in this application with reference to FIGS. 5 and 9A-E. As part of dynamic instrument limit book creation, exchange server 104 may create products and components for the new market and begin real-time price discovery and trading. In block 224, exchange server 104 may finish processing the request. The method in FIG. 2 may proceed to block 226 and end, may repeat one or more times, or may return to any of the preceding blocks.

FIG. 3 illustrates a flow diagram for posting a new market with dynamic instrument limit book creation in accordance with example embodiments. The flow diagram may be implemented by a system or apparatus, such as, for example, exchange server 104. Each of the blocks shown in the flow diagram may be repeated one or more times, one or more of the blocks may be modified, and one or more of the blocks may be omitted. The flow diagram may be stored on a non-transitory computer readable medium as computer executable instructions. The computer executable instructions, when executed by at least one processor, may cause at least one computer or other device to perform the blocks as steps of a method one or more times. The flow diagram may begin at block 302.

In block 302, exchange server 104 may post a new market. Posting of a new market may involve creation of new limit books for previously unknown instruments, both “relatively” specified and “specifically” specified. These new limit books may be dynamically created in response to new market requests.

In block 304, exchange server 104 may determine whether to create a new instrument limit book. If a new limit book is to be created, exchange server 104 may, in block 306, create the new limit book. New limit books may be dynamically created for each new instrument generated by the new market request. In some examples, newly created limit books may be available for immediate use. An example of creating a new limit book is further described with reference to FIG. 6. Once created, the flow diagram may return to block 304. If no new limit books are to be created, the flow diagram may proceed to block 308.

In block 308, exchange server 104 may post new markets according to defined rules. In block 310, exchange server may acknowledge a posted status. In block 312, exchange server 104 may publish market change notification. The method in FIG. 3 may proceed to block 314 and end, may repeat one or more times, or may return to any of the preceding blocks.

FIG. 4 illustrates a flow diagram of a process for executing a trade request with dynamic instrument limit book creation in accordance with example embodiments. The flow diagram may be implemented by a system or apparatus, such as, for example, exchange server 104. Each of the blocks shown in the flow diagram may be repeated one or more times, one or more of the blocks may be modified, and one or more of the blocks may be omitted. The flow diagram may be stored on a non-transitory computer readable medium as computer executable instructions. The computer executable instructions, when executed by at least one processor, may cause at least one computer or other device to perform the blocks as steps of a method one or more times. The flow diagram may begin at block 402.

In block 402, exchange server 104 may initiate an execute trade request process. In block 404, exchange server 104 may determine whether a new limit book is to be created. If yes, exchange server 104 may, in block 406, create a new limit book. For some markets, including those for “relatively” specified instruments (but not limited to), exchange server 104 may generate “specifically” specified instruments, fill prices, etc., to permit trade execution. In these cases, for previously unknown instruments, new limit books may be dynamically created. New limit books may be dynamically created for each new instrument generated by the trade. In some examples, newly created limit books may be available for immediate use. An example of creating a new limit book is further described with reference to FIG. 6. Once any desired limit books have been created, the process may proceed to block 408.

In block 408, exchange server 104 may execute a fill at a price and size. In block 410, exchange server 104 may update the posted market. In block 412, exchange server 104 may send fill and status reports to counterparties. In block 414, exchange server 104 may publish market change notifications. The method in FIG. 4 may proceed to block 416 and end, may repeat one or more times, or may return to any of the preceding blocks.

FIG. 5 illustrates a flow diagram of a process for requesting a new instrument limit book with dynamic instrument limit book creation in accordance with example embodiments. The flow diagram may be implemented by a system or apparatus, such as, for example, exchange server 104. Each of the blocks shown in the flow diagram may be repeated one or more times, one or more of the blocks may be modified, and one or more of the blocks may be omitted. The flow diagram may be stored on a non-transitory computer readable medium as computer executable instructions. The computer executable instructions, when executed by at least one processor, may cause at least one computer or other device to perform the blocks as steps of a method one or more times. The flow diagram may begin at block 502.

In block 502, exchange server 104 may receive a request to create a new instrument limit book. In block 504, exchange server 104 may determine whether to create a new limit book. In some examples, various market related requests including, but not limited to, Request-For-Quotes, new instrument creation, etc., may involve creation of new products and components to support price discovery and trading. In these cases, for previously unknown instruments, these new limit books may be dynamically created. New limit books may be dynamically created for each new instrument defined in the request. In some examples, newly created limit books may be available for immediate use. If a new limit book is to be created, exchange server 104 may, in block 506, create the limit book. An example of creating a new limit book is further described with reference to FIG. 6. Once any desired limit books have been created, the process may proceed to block 508 and end, may repeat one or more times, or may return to any of the preceding blocks.

FIG. 6 illustrates a flow diagram of a process for dynamic instrument limit book creation in accordance with example embodiments. The flow diagram may be implemented by a system or apparatus, such as, for example, exchange server 104. Each of the blocks shown in the flow diagram may be repeated one or more times, one or more of the blocks may be modified, and one or more of the blocks may be omitted. The flow diagram may be stored on a non-transitory computer readable medium as computer executable instructions. The computer executable instructions, when executed by at least one processor, may cause at least one computer or other device to perform the blocks as steps of a method one or more times. The flow diagram may begin at block 602.

In block 602, exchange server 104 may initiate a new instrument limit book creation process. In block 604, exchange server 104 may create a new financial instrument and associated resources. In an example, exchange server 104 may receive data including one or more of: supplied instrument data, real-time market data, real-time analytics, instrument creation models, exchange models, rules, data, etc. For instance, the exchange server 104 may receive a new market request that requests creation of a market for trading of a new financial instrument, wherein the request identifies an instrument type, quantity, and price. In response to the request, the exchange server 104 may create a financial instrument based on the instrument type, quantity, and price. Exchange server 104 may customize and bind real-time dynamic instrument creation processes to each instrument type, both “relatively” specified and “specifically” specified. Depending on instrument type, creation may depend directly and indirectly on the given specification, associated instrument data, real-time market data, real-time reference data including (but not limited to) interest rates and volatilities, analytic data and processes including (but not limited to) rate term structures and volatility surfaces, exchange data and rule based parameters, and creation and management processes. Newly created instruments may be persisted and, in some examples, may be available for immediate use. In block 620, exchange server 104 may repeat the instrument creation process for each new instrument required to price discover and trade the newly created instruments. In block 622, exchange server 104 gathers resources to be used for the instrument type from the initiating request, a run-time environment for the exchange server 104, and real-time discoverable dynamic caches. In block 624, exchange server 104 retrieves construction models from real-time discoverable dynamic caches, where construction models are unique for each instrument type. In block 626, exchange server 104 applies the construction models to build the new instrument and binds the instrument to its data and resources. In block 628, exchange server 104 persists the new instrument, binds the new instrument to the exchange server 104 real-time environment, and prepares the new instrument for use.

In block 606, exchange server may create pricing models and associated resources. To create the models, exchange server 104 may receive data including one or more of: supplied instrument data, quantitative models, creation models, exchange models, rules, data, etc. Exchange server 104 may create and bind pricing, risk, and other quantitative models dynamically to the newly created instrument. In some instances, newly created instruments may be configured and available for immediate use. The model creation processes may depend on instrument type, analytic processes, and exchange data, rules, etc. In block 630, exchange server 104 may repeat the pricing model creation process for each new pricing model used to price newly created instruments. In block 632, exchange server 104 gathers resources from the initiating request used by the pricing model, run-time environment, and real-time discoverable dynamic caches. In block 634, exchange server 104 retrieves construction models from real-time discoverable dynamic caches, where construction models are unique for each instrument type. In block 636, exchange server 104 applies the construction models to build the new pricing model and binds the pricing model to its data and resources. In block 638, exchange server 104 persists the new pricing model, binds the new pricing model to the exchange server 104 real-time environment, and prepares the new pricing model for use.

In block 608, exchange server 104 may create a limit book and associated resources. To create the limit book, exchange server 104 may receive data including one or more of: supplied instrument data, limit book creation models, exchange models, rules, data, etc. In some examples, exchange server 104 may, using real-time dynamic limit book creation processes, customize and bind each instrument type, both “relatively” specified and “specifically” specified. The instrument types may thus be configured and available for immediate use. In some instances, the creation processes may depend on instrument type, analytic processes, and exchange data, rules, etc. In block 640, exchange server 104 may repeat the limit book creation process for each new limit book used to price discover and trade newly created instruments. In block 642, exchange server 104 gathers resources used by the limit book from the initiating request, the exchange server 104 run-time environment, and real-time discoverable dynamic caches. In block 644, exchange server 104 retrieves construction models from real-time discoverable dynamic caches, where construction models are unique for each instrument type. In block 646, exchange server 104 applies the construction models to build the new limit book and binds the limit book to its data and resources. In block 648, exchange server 104 persists the limit book, binds the new limit book to the exchange server 104 real-time environment, and prepares the new limit book for use.

In block 610, exchange server 104 may create at least one fill/execution model and associated resources. To create a fill model, exchange server 104 may receive data including one or more of: supplied instrument data, quantitative models, fill process creation models, exchange properties, rules, etc. In some examples, each instrument type may use a custom fill model to correctly execute associated market trades. Exchange server 104, using fill model creation processes, may dynamically create these models and bind them to the newly created limit books. In some examples, the models may be configured and available for immediate use. In some instances, the creation process depend on instrument type, analytic processes, and exchange data, rules, etc. In block 650, exchange server 104 may repeat the fill model creation process for each new fill model required by the newly created limit books. In block 652, exchange server 104 gathers resources used by the fill model from the initiating request, the exchange server 104 run-time environment, and real-time discoverable dynamic caches. In block 654, exchange server 104 retrieves construction models from real-time discoverable dynamic caches, where construction models are unique for each limit book and instrument type. In block 656, exchange server 104 applies the construction models to build the new fill model and bind the fill model to its data and resources. In block 658, exchange server 104 persists the new fill model, binds the new fill model to its limit book and exchange server 104 real-time environment, and prepares the new fill model for use.

In block 612, exchange server 104 may initialize and prepare new instruments, limit books, price models, fill models, rule models, etc. In an example, exchange server 104 may perform final parameterization and initialization for a newly created instrument limit book, persist the new instrument limit book data associated persistence models, and establish final exchange connections. Once created, the new instrument limit book may be immediately available for posting, price discovery, trading, and all other defined workflows.

In block 614, exchanger server 104 may activate the new instrument limit book for real-time price discovery and trading. In block 616, exchange server 616 may publish new limit book notifications. In an example, exchange server 104 may notify one or more exchange participants of a newly created limit book and tradable instrument that are ready for use. The process may proceed to block 618 and end, may repeat one or more times, or may return to any of the preceding blocks.

The discussion below provides more detailed examples of the concepts described above. FIGS. 7A-E describe an example of posting a new market with dynamic instrument limit book creation in accordance with example embodiments of the present disclosure. FIGS. 8A-G describe an example of executing a trade request with dynamic instrument limit book creation in accordance with example embodiments of the present disclosure. FIGS. 9A-E describe an example of requesting a new instrument limit book with dynamic instrument limit book creation in accordance with example embodiments of the present disclosure. FIGS. 10A-G describe an example of executing a trade request with dynamic instrument limit book creation in accordance with example embodiments of the present disclosure.

With reference to FIG. 7A, an example post new market request 700 is depicted. In this example, client terminal 102 may send request 700 to post a new market for a previously unknown relatively specified OTC FX Option Straddle. Along with administrative, price and quantity details, the new market request may, in some examples, specify details of the new straddle instrument. In an example, the option straddle may be a multi-leg instrument where one buys or sells one call and one put at the same maturity and strike. As a relatively specified instrument, the option maturities may be specified as tenors relative to the request date, and the strikes may be specified as deltas or ‘moneyness’ relative to the at-the-money or 0 delta. In an example, the new option straddle may be priced in terms of volatility.

To post this market and provide pre-trade price discovery to some or all connected client terminals, exchange server 104 may dynamically create a new straddle market, post a bid and/or offer, and distribute new market prices. If a new market cannot be created, exchange server 104 may reject the request. In general, different instrument types may use different creation processes. In an example, exchange server 104 may use a dynamic instrument limit book creation defined for relatively specified straddles to create up to three new markets: one for the call instrument if not currently defined, one for the put instrument if not currently defined, and one for the new straddle multi-leg instrument.

The limit book creation process may manufacture new instruments along with quantitative pricing models and algorithms, limit books, fill models, validation models, prioritization models, rule models, components, data, bindings, etc., for each new limit book. Once created, exchange server 104 may bind new instruments, pricing models, and limit books to an exchange run-time environment, and connected client terminals may be notified of the newly created instruments and markets. Exchange server 104 may then ready the new limit books for immediate use, the first use being posting and disseminating the new straddle bid and offer price and quantity. Though described here for relatively specified OTC FX Option Straddles, this process may apply equivalently to other instrument types including, for example, relatively specified instruments, specifically specified instruments, etc.

FIGS. 7B-E illustrate operations performed by a client terminal 102, and exchange process 702 and factory process 704 performed by exchange server 104. Exchange process 702 may relate to operations associated with implementing an exchange, and factory process 704 may relate to operations associated with new instrument limit book creation.

With reference to FIG. 7B, in block 7.1, client terminal 102 may submit a new market request for a previously unknown relatively specified OTC FX Option Straddle (e.g., buy one 2-week 50-delta call and buy one 2-week 50-delta put). Along with system identifiers, time stamps, and content, the new market request, in an example, submits a new bid price of 10.9 volatility and size of 5,000,000 and a new offer price of 11.1 volatility and size of 5,000,000. Additionally, the request may contain a full description of the new straddle instrument. Upon receipt, exchange server 104 may record receipt for state management, audit trail, and other future uses, and invoke a defined handler process assigned to this request type. In this example, the assigned handler process may implement a posting process and a dynamic instrument limit book creation process defined for the instrument type.

In block 7.2, exchange server 104 may validate the structure and contents of the relatively specified OTC FX Option Straddle post market request and acknowledge receipt by replying with an optional acceptance notification or a rejection notification due to errors. Exchange server 104 may begin validation with basic system level checks for proper structure, identifiers, time stamps, common content, etc., which may continue throughout the dynamic instrument limit book creation.

In block 7.2.a, exchange server 104 may acknowledge receipt of the new market request by replying with a system level message.

In block 7.2.b, exchange server 104 optionally may acknowledge receipt of the new market request by replying with a system level reject due to, for example, errors in the structure or system level contents of the request (e.g., malformed structure, erroneous or missing identifiers, time stamps, content, etc.). The exchange server 104 may record the reject message for state management, audit trail, and other future uses.

In block 7.3, exchange server 104 may post the requested new relatively specified OTC FX Option Straddle market, but, as no executable market yet exists, the request may not be executable. Exchange server 104 may invoke a dynamic instrument limit book creation process to dynamically create, bind, initialize, and run all structures, components, processes, data, etc. to price discover and trade the new straddle market, including, but not limited to, instruments, pricing models, limit books, fill models, validation models, prioritization models, etc. The dynamic instrument limit book creation process may create markets to define related markets. In an example, for the new straddle, the creation process may create up to three new markets: one for the call if not currently defined, one for the put if not currently defined, and one for the straddle multi-leg strategy. The process may begin with dynamic instrument creation.

In block 7.3.a.1, exchange server 104 may invoke a dynamic instrument creation process assigned to the requested instrument type (e.g., relatively specified OTC FX Option Straddle). In general different instrument types may use different creation processes. Instrument creation processes may be predefined and run-time discoverable by instrument type. In general, the instrument creation process may involve on-demand and/or continuous real-time pricing of related instruments, which may involve discoverable static and real-time markets, reference data sources, rate term structures, volatility term structures, etc., along with associated quantitative algorithms and pricing models.

In block 7.3.a.2, exchange server 104 may retrieve instrument templates and associated components and data defined for the requested instrument type (e.g., relatively specified OTC FX Option Straddle), and may ready them for construction. These templates, components, and data may be predefined and run-time discoverable by instrument type. When combined with instrument specification data contained in the request, they may be used to create, integrate, and bind the new instruments to the exchange run-time environment.

In block 7.3.a.3, exchange server 104 may retrieve instrument builder models and associated processes, components, and data, and may ready them for construction. These models, processes, components, and data may be predefined and run-time discoverable by instrument type.

In block 7.3.a.4, exchange server 104 may create new instruments by applying the builder models and processes to the instrument specification data in the new market request and the assembled templates and associated components, data, etc.

In block 7.3.a.5, exchange server 104 may persist the new instruments and associated components, data, etc. In memory or other storage device (e.g., in its permanent store) for future reference and to manage their life cycles.

In block 7.3.a.6, exchange server 104 optionally may generate an error message (e.g., application level reject) if, for example, the new instruments and associated components, data, etc., cannot be created due to erroneous instrument specifications, missing data, and/or internal errors.

In block 7.2.c, exchange server 104 optionally may send an application level reject (e.g., due to missing, malformed, and/or erroneous instrument specifications for the new relatively specified OTC FX Option Straddle; the new associated instruments, data, and components etc., cannot be dynamically created and the requested market cannot be posted). The exchange server 104 may record the reject message for state management, audit trail, and other future uses.

In block 7.3.a.7, if no error is identified, exchange server 104 may return the newly created relatively specified OTC FX Option Straddle instruments and associated components and data.

In block 7.3.a.8, exchange server 104 may complete configuration, binding and initialization of the newly created relatively specified FX Option Straddle instruments and associated components, data, etc., and may ready them for use.

With reference to FIG. 7C, in block 7.3.a.9, exchange server 104 may send new instrument creation messages for newly created relatively specified OTC FX Option Straddle instruments to the requesting client terminal 102 and optionally unsolicited to at least one other client terminal 102 (e.g., with a previously registered interest in receiving new instrument updates). For example, other client terminals 102 may request a snapshot of currently defined instruments and to receive ongoing unsolicited notification of some or all instruments created in the future. Client terminals 102 may also cancel their ongoing interest in future instrument creation updates at any time.

In block 7.3.b.1, exchange server 104 may invoke a dynamic pricing model creation process assigned to the requested instrument type (e.g., relatively specified OTC FX Option Straddle). In general, different instrument types may use different creation processes for associated pricing models, algorithms, components, data, etc. These creation processes may be predefined and run-time discoverable. The pricing model process may use on demand or continuous real-time pricing of related instruments, which may use run-time discoverable associated static and real-time markets, reference data sources, rate term structures, volatility term structures, etc., and associated quantitative algorithms and pricing models. The pricing model creation process may create as many pricing model and associated algorithms, and data bindings as desired such that related instruments may be on-demand/real-time price-able. In an example, for the new straddle, the creation process may create up to three new sets of pricing models: one for the call if not currently defined, one for the put if not currently defined, and one for the straddle multi-leg strategy.

In block 7.3.b.2, exchange server 104 may retrieve model templates and associated algorithms, components and data defined for the requested instrument type (e.g., relatively specified OTC FX Option Straddle), and may ready them for construction. These templates, algorithms, components, and data may be predefined and run-time discoverable by instrument type. When combined with the specification data contained in the request, they may be used to create, integrate, and bind new pricing models and algorithms to the exchange run-time environment.

In block 7.3.b.3, exchange server 104 may retrieve associated static/real-time market data, reference data, rate term structures, volatility term structures, and other related data bindings and templates, and may ready them for construction. These bindings, templates, and data may be predefined and run-time discoverable by instrument type.

In block 7.3.b.4, exchange server 104 may retrieve at least one pricing model builder model and associated processes, components, and data, and may ready them for construction. These builder models, processes, components, and data may be predefined and run-time discoverable by instrument type.

In block 7.3.b.5, exchange server 104 may create the new pricing models by applying the builder models and processes to the instrument specification data in the request and the assembled creation templates and associated algorithms, components, data, etc.

In block 7.3.b.6, exchange server 104 optionally may return an error (e.g., application level reject) if, for example, the new pricing models and associated algorithms, components, data, etc. cannot be created due to erroneous instrument specifications, missing data, and/or internal errors.

In block 7.2.d, exchange server 104 may send an application level reject (e.g., due to missing, malformed, and/or, erroneous instrument specifications for the new relatively specified OTC FX Option Straddle; the new associated pricing models, algorithms, data, and components, etc., cannot be dynamically created and the requested market cannot be posted). The exchange server 104 may record the reject message for state management, audit trail, and other future uses.

In block 7.3.b.7, if no error is identified, exchange server 104 may return the newly created pricing models and associated algorithms, components and data.

In block 7.3.b.8, exchange server 104 may complete final pricing model configuration, binding and initialization of the newly created pricing models and associated algorithms, components, data, etc., and may ready them for use.

In block 7.3.b.9, exchange server 104 may complete final configuration and initialization of the market data, reference data, rate term structures, volatility term structures, etc., bind the newly created pricing models and associated algorithms, components, data, etc., and may ready them for use.

In block 7.3.b.10, exchange server 104 may bind the newly created pricing models and associated algorithms to the exchange real-time pricing environment and may begin pricing newly created instruments.

With reference to FIG. 7D, in block 7.3.c.1, exchange server 104 may invoke a dynamic limit book creation process assigned to the requested instrument type (e.g., relatively specified OTC FX Option Straddle). In general, different instrument types may use different creation processes for associated limit books, validation models, prioritization models, fill models, miscellaneous rule models, etc. These creation processes may be predefined and run-time discoverable. The limit book creation process may involve on demand or continuous real-time pricing of associated instruments, which may use run-time discoverable on-demand and real-time markets, reference data sources, rate term structures, volatility term structures, etc., and associated quantitative algorithms and pricing models. The limit book creation process may create as many limit books and associated fill models, validation models, prioritization models, rule models, and data bindings as desired so that related instruments may be real-time price discoverable and tradable. In an example, for the new straddle, the creation process may create up to three new sets of limit books: one for the call if not currently defined, one for the put if not currently defined, and one for the straddle multi-leg strategy.

In block 7.3.c.2, exchange server 104 may retrieve limit book model templates and associated algorithms, components and data defined for the requested instrument type (e.g., relatively specified OTC FX Option Straddle), and may ready them for construction. These model templates, algorithms, components, and data may be predefined and run-time discoverable by instrument type. When combined with the specification data contained in the request, they may be used to create, integrate, and bind the limit book models into the exchange run-time environment.

In block 7.3.c.3, exchange server 104 may retrieve associated validation model templates and associated algorithms, components, and data, and may ready them for construction. These validation model templates, components, and data may be predefined and run-time discoverable by instrument type.

In block 7.3.c.4, exchange server 104 may retrieve associated prioritization model templates and associated algorithms, components, and data, and may ready them for construction. These prioritization model templates, components, and data may be predefined and run-time discoverable by instrument type.

In block 7.3.c.5, exchange server 104 may retrieve associated fill/execution model templates and associated algorithms, components, and data, and may ready them for construction. These fill/execution model templates, components, and data may be cached or predefined and discoverable by instrument type.

In block 7.3.c.6, exchange server 104 may retrieve other associated rule model templates, algorithms, components, and data, and may ready them for construction. These rule models templates, algorithms, components, and data may be predefined and run-time discoverable by instrument type.

In block 7.3.c.7, exchange server 104 may retrieve associated bindings for associated on-demand/real-time market data, reference data, rate term structures, volatility term structures, and other related data and may ready them for construction. These bindings and data may be predefined and run-time discoverable by instrument type.

In block 7.3.c.8, exchange server 104 may retrieve limit book builder models and associated processes, components, and data, and may ready them for construction. These builder models, processes, components, and data may be predefined and run-time discoverable by instrument type.

In block 7.3.c.9, exchange server 104 may create new limit books by applying the builder models and processes to the instrument specification data in the request and the assembled creation templates, algorithms, components, data, etc. Associated newly created instruments, validation models, prioritization models, fill/execution models, miscellaneous rule models, components, date, etc. may be created, bound, and initialized, and readied for use.

In block 7.3.c.10, exchange server 104 optionally may return an error if, for example, the new limit books and associated algorithms, components, data, etc., cannot be created due to erroneous instrument specifications, missing data, and/or internal errors. In turn, exchange server 104 may reply to the new market request with an application level reject (7.2.e).

In block 7.3.c.11, if no error is identified, exchange server 104 may return the newly created limit books and associated algorithms, components and data.

In block 7.3.c.12, exchange server 104 may complete final limit book configuration, binding and initialization of the newly created limit books and associated algorithms, components and data for use.

With reference to FIG. 7E, in block 7.3.c.13, exchange server 104 may complete final binding of on-demand/real-time market data, reference data, rate term structures, volatility term structures, etc., and may ready them for use.

In block 7.3.c.14, exchange server 104 may complete final binding of the newly created limit books to the exchange run-time environment and may ready them for use.

In block 7.4.a, exchange server 104 may post the new relatively specified OTC FX Option Straddle bid and offer to the newly created limit book.

In block 7.4.b, exchange server 104 may validate the new bid and offer using its validation models.

In block 7.4.c, exchange server 104 optionally may reject the new bid and offer due to validation rule violations. In turn, exchange server 104 may reply to the new market request with an application level reject (2.f).

In block 7.4.d, if no error is identified, exchange server 104 may post the new bid and offer according to its prioritization and rule models.

In block 7.4.e, exchange server 104 may not return fills/executions for the newly created markets as there are not yet any markets to trade against.

In block 7.4.f, exchange server 104 may post a new best bid and/or offer for the new relatively specified OTC FX Option Straddle market.

In block 7.4.g, exchange server 104 may determine that a new best bid and/or offer has been posted. In turn, exchange server 104 may notify one or more client terminals with a previously registered interest of the posted new best bid and/or offer.

In block 7.4.h, exchange server 104 may send unsolicited new best bid and/or offer notification messages to other client terminals with a previously registered interest in receiving new best bid and/or offer updates. In some examples, client terminals 102 may request a snapshot of currently defined best bids and offers, and to receive ongoing unsolicited notification of some or all future changes to the best bids and offers. Client terminals 102 may cancel their ongoing interest in future changes to the best bids and offers at any time.

In block 7.4.i, exchange server 104 may post a change to its structure or depth of book for the new relatively specified OTC FX Option Straddle market.

In block 7.4.j, exchange server 104 may determine changes to one or more of the books structure or depth of book. In turn, exchange server 104 may notify some or all client terminals with a previously registered interest.

In block 7.4k exchange server 104 may send unsolicited new depth of book notification messages to some or all client terminals with a previously registered interest in receiving new depth of book updates. For example, client terminals 102 may request a snapshot of current depth of books, and to receive ongoing unsolicited notification of some or all future changes to depth of books. Client terminals 102 may cancel their ongoing interest in future changes to depth of books at any time.

FIGS. 8A-G describe an example of executing a trade request with dynamic instrument limit book creation in accordance with example embodiments. In this example, client terminal 102 may send a buy order request 800 to trade against a previously posted offer price and quantity for a relatively specified OTC FX Option Risk-Reversal. The option risk-reversal may be a multi-leg instrument where one buys one call and sells one put at the same maturity but different strikes, with the strikes typically representing equivalent delta exposures. As a relatively specified instrument, the option maturities may be specified as tenors relative to the request date, and the strikes may be specified as deltas or ‘moneyness’ relative to the at-the-money or 0 delta. The new option risk-reversal may be priced in terms of the volatility spread between the call and put.

Trade execution of relatively specified instrument types may generate the agreed upon specifically specified instruments at the time of the trade, the specifics and associated prices may be defined by rules, market conventions, and negotiation between parties. Consequently, execution of the requested trade may involve exchange server 104 creating the specifically specified instrument limit books associated with the trade, record and report the trade details to both parties, and distribute the new trade prices/quantities. Additionally, for relatively specified risk-reversal, exchange server 104 may record and report trade details and distribute changes to top-of-book and depth-of-book. If a required limit book cannot be created, exchange server 104 may reject the request. Any residual un-executed quantity that can post may follow the “post new market” process described above in FIGS. 7A-E.

In general, different instrument types may use different creation processes. In this example, exchange server 104 may create up to three new markets: one for the call instrument if not currently defined, one for the put instrument if not currently defined, and one for the risk-reversal multi-leg instrument if not currently defined.

The instrument limit book creation process may manufacture new instruments along with quantitative pricing models and algorithms, limit books, fill models, validation models, prioritization models, rule models, components, data, bindings, etc., used for each new market. Once created, new instruments, pricing models, and limit books may be bound to the exchange run-time environment, and connected client terminals may be notified of the newly created instruments and markets. The exchange server 104 may then ready the new markets for immediate use. Though described here for specifically specified OTC FX Option Risk-Reversals, this process may apply to instrument of other types, including, for example, relatively specified instruments, specifically specified instruments, etc.

FIGS. 8B-G illustrate operations performed by a client terminal 102, and exchange process 802 and relative risk-reversal limit process 804 performed by exchange server 104. With reference to FIG. 8B, in block 8.1, client terminal 102 may submit a request (e.g., to buy 5,000,000 of a relatively specified OTC FX Option Risk-Reversal: buy one 1-month 25-delta call and sell one 1-month 25 delta put, at a previously posted offer price of 2.1 volatility, where the price represents the spread between the volatility of the call and the volatility of the put). As a limit buy order good for the day, any unfilled residual size may be posted at the limit price of 2.1 volatility. The request may contain any additional information used to calculate the specifically specified call and put fills, and create their instruments. Upon receipt, exchange server 104 may record receipt for state management, audit trail, and other future uses, and may invoke defined handler process assigned to this request type. In this example, the assigned handler process may implement a fill process for day limit orders, posting process, and a dynamic instrument limit book creation process defined for this instrument type.

In block 8.2, exchange server 104 may validate the structure and contents of the relatively specified OTC FX Option risk-reversal buy request and acknowledge receipt by replying with an optional acceptance notification or a rejection notification due to errors. Validation may begin with basic system level checks for proper structure, identifiers, time stamps, common content, etc., and may continue throughout the fill, posting, and dynamic instrument limit book creation processes.

In block 8.2.a, exchange server 104 may acknowledge receipt of the buy request by replying with a system level acknowledgement message. The exchange server 104 may record the buy request for state management, audit trail, and other future uses.

In block 8.2.b, exchange server 104 may determine whether there are errors in the structure or system level contents of the request (e.g., malformed structure, erroneous or missing identifiers, time stamps, content, etc.) and, if errors are identified, may communicate an application level reject message. The exchange server 104 may record the reject message for state management, audit trail, and other future uses.

In block 8.3, exchange server 104 may, if no errors are identified, execute the request to buy 5,000,000 of the relatively specified OTC FX Option Risk-Reversal, if an executable market exists, and may post any unfilled residual quantity. The fill process may further create specifically specified instruments to complete the trades. Accordingly, exchange server 104 may invoke a dynamic instrument limit book creation process to dynamically create, bind, initialize, and run structures, components, processes, data, etc., used to price discover and trade the new specifically specified OTC FX Option Risk-Reversal market, including, but not limited to, instruments, pricing models, limit books, fill models, validation models, prioritization models, etc. The dynamic instrument limit book creation process may create as many markets as desired to define related markets. In an example, for the new specifically specified risk-reversal, the creation process may create up to three new markets: one for the call if not currently defined, one for the put if not currently defined, and one for the risk-reversal multi-leg strategy. The process may begin with dynamic instrument creation.

In block 8.3.a.1, exchange server may invoke a dynamic instrument creation process assigned to the fill instrument type (e.g., specifically specified OTC FX Option Risk-Reversal). In general different instrument types may use different creation processes. Instrument creation processes may be predefined and run-time discoverable by instrument type. In general, the instrument creation process may provide on-demand and/or continuous real-time pricing of related instruments, which may use discoverable static and real-time markets, reference data sources, rate term structures, volatility term structures, etc., along with associated quantitative algorithms and pricing models.

In block 8.3.a.2, exchange server 104 may retrieve instrument templates and associated components and data defined for the fill instrument type (e.g., specifically specified OTC FX Option Risk-Reversal), and may ready them for construction. These templates, components, and data may be predefined and run-time discoverable by instrument type. When combined with the instrument specification data contained in the relatively specified risk-reversal market and the buy request, they may be used to create, integrate, and bind the new instruments to the exchange run-time environment.

In block 8.3.a.3, exchange server 104 may retrieve instrument builder models and associated processes, components, and data, and may ready them for construction. These models, processes, components, and data may be predefined and run-time discoverable by instrument type.

In block 8.3.a.4, exchange server 104 may create new instruments by applying the builder models and processes to the instrument specification data in the request and the assembled templates and associated components, data, etc.

In block 8.3.a.5, exchange server 104 may persist the new instruments and associated components, data, etc., to memory or other type of storage (e.g., in its permanent store) for future reference and to manage their life cycles.

In block 8.3.a.6, exchange server 104 optionally may identify an error (e.g., the new instruments and associated components, data, etc., cannot be created due to erroneous instrument specifications, missing data, and/or internal errors).

In block 8.2.c, exchange server 104 may, if an error is identified, send an application level reject (e.g., due to missing, malformed, and/or erroneous information preventing execution of a trade for the relatively specified OTC FX Option Risk-Reversal; the new associated specifically specified instruments, data, and components etc., cannot be dynamically created, and the requested trade cannot be completed). The exchange server 104 may record the reject message for state management, audit trail, and other future uses.

With reference to FIG. 8C, in block 8.3.a.7, exchange server 104 may return the newly created specifically specified OTC FX Option Risk-Reversal instruments and associated components and data.

In block 8.3.a.8, exchange server 104 may complete final configuration, binding and initialization of the newly created specifically specified OTC FX Option Risk-Reversal instruments and associated components, data, etc., and may ready them for use.

In block 8.3.a.9, exchange server 104 may send unsolicited new instrument creation messages for newly created specifically specified OTC FX Option Risk-Reversal instruments to some or all client terminals 102 with a previously registered interest in receiving new instrument updates. For example, client terminals 102 may request a snapshot of currently defined instruments and to receive ongoing unsolicited notification of some or all instruments created in the future. Client terminals 102 may cancel their ongoing interest in future instrument creation updates at any time.

In block 8.3.b.1, exchange server 104 may invoke dynamic pricing model creation processes assigned to the fill instrument type (e.g., specifically specified OTC FX Option Risk-Reversal). In general, different instrument types may use different creation processes for associated pricing models, algorithms, components, data, etc. These creation processes may be predefined and run-time discoverable. The pricing model process may use on demand or continuous real-time pricing of related instruments, which may use run-time discoverable associated static and real-time markets, reference data sources, rate term structures, volatility term structures, etc., and associated quantitative algorithms and pricing models. The pricing model creation process may create as many pricing model and associated algorithms, and data bindings such that related instruments may be on-demand/real-time price-able. In an example, for the new specifically specified risk-reversal, the creation process may create up to three new sets of pricing models: one for the call if not currently defined, one for the put if not currently defined, and one for the risk-reversal multi-leg strategy.

In block 8.3.b.2, exchange server 104 may retrieve model templates and associated algorithms, components and data defined for the fill instrument type (e.g., specifically specified OTC FX Option Risk-Reversal), and may ready them for construction. These templates, algorithms, components, and data may be predefined and run-time discoverable by instrument type. When combined with the specification data contained in the request, they may be used to create, integrate, and bind the new pricing models and algorithms to the exchange run-time environment.

In block 8.3.b.3, exchange server 104 may retrieve associated static/real-time market data, reference data, rate term structures, volatility term structures, and other related data bindings and templates, and readies them for construction. These bindings, templates, and data may be predefined and run-time discoverable by instrument type.

In block 8.3.b.4, exchange server 104 may retrieve pricing model builder models and associated processes, components, and data, and readies them for construction. These builder models, processes, components, and data may be predefined and run-time discoverable by instrument type.

In block 8.3.b.5, exchange server 104 may create new pricing models by applying the builder models and processes to the instrument specification data in the request and assembled creation templates and associated algorithms, components, data, etc.

In block 8.3.b.6, exchange server 104 optionally may identify an error (e.g., the new pricing models and associated algorithms, components, data, etc., cannot be created due to erroneous instrument specifications, missing data, and/or internal errors).

With reference to FIG. 8D, in block 8.2.d, exchange server 104 may, if an error is identified, send an application level reject (e.g., due to missing, malformed, and/or, erroneous information preventing execution of a trade for the relatively specified OTC FX Option Risk-Reversal; the new associated pricing models, algorithms, data, and components etc., for the new specifically specified instruments cannot be dynamically created and the requested trade cannot be completed, etc.). The exchange server 104 may record the reject message for state management, audit trail, and other future uses.

In block 8.3.b.7, exchange server 104, if no errors have been identified, may return the newly created pricing models and associated algorithms, components and data.

In block 8.3.b.8, exchange server 104 may complete pricing model configuration, binding and initialization of the newly created pricing models and associated algorithms, components, data, etc., and may ready them for use.

In block 8.3.b.9, exchange server 104 may complete configuration and initialization of the market data, reference data, rate term structures, volatility term structures, etc., bind the newly created pricing models and associated algorithms, components, data, etc., and may ready for use.

In block 8.3.b.10, exchange server 104 may bind the newly created pricing models and associated algorithms to the exchange real-time pricing environment and begin pricing newly created instruments.

In block 8.3.c.1, exchange server 104 may invoke a dynamic limit book creation process assigned to the fill instrument type (e.g., specifically specified “On-The-Fly” FX Option Risk-Reversal). In general, different instrument types may use different creation processes for associated limit books, validation models, prioritization models, fill models, miscellaneous rule models, etc. These creation processes may be predefined and run-time discoverable. The limit book creation process may use on demand or continuous real-time pricing of associated instruments, which may use run-time discoverable on-demand and real-time markets, reference data sources, rate term structures, volatility term structures, etc., and associated quantitative algorithms and pricing models. The limit book creation process may create as many limit books and associated fill models, validation models, prioritization models, rule models, and data bindings as desired so that related instruments are real-time price discoverable and tradable. In an example, for the new specifically specified risk-reversal, the creation process may create up to three new sets of limit books: one for the call if not currently defined, one for the put if not currently defined, and one for the risk-reversal multi-leg strategy.

In block 8.3.c.2, exchange server 104 may retrieve limit book model templates and associated algorithms, components and data defined for the fill instrument type (e.g., specifically specified OTC FX Option Risk-Reversal), and may ready them for construction. These model templates, algorithms, components, and data may be predefined and run-time discoverable by instrument type. When combined with the specification data contained in the request, they may be used to create, integrate, and bind the limit book models into the exchange run-time environment.

In block 8.3.c.3, exchange server 104 may retrieve associated validation model templates and associated algorithms, components, and data, and may ready them for construction. These validation model templates, components, and data may be predefined and run-time discoverable by instrument type.

In block 8.3.c.4, exchange server 104 may retrieve associated prioritization model templates and associated algorithms, components, and data, and may ready them for construction. These prioritization model templates, components, and data may be predefined and run-time discoverable by instrument type.

In block 8.3.c.5, exchange server 104 may retrieve associated fill/execution model templates and associated algorithms, components, and data, and may ready them for construction. These fill/execution model templates, components, and data may be cached or predefined and discoverable by instrument type.

In block 8.3.c.6, exchange server 104 may retrieve other associated rule model templates, algorithms, components, and data, and may ready them for construction. These rule models templates, algorithms, components, and data may be predefined and run-time discoverable by instrument type.

In block 8.3.c.7, exchange server 104 may retrieve associated bindings for associated on-demand/real-time market data, reference data, rate term structures, volatility term structures, and other related data and may ready them for construction. These bindings and data may be predefined and run-time discoverable by instrument type.

With reference to FIG. 8E, in block 8.3.c.8, exchange server 104 may retrieve limit book builder models and associated processes, components, and data, and may ready them for construction. These builder models, processes, components, and data may be predefined and run-time discoverable by instrument type.

In block 8.3.c.9, exchange server 104 may create new limit books by applying the builder models and processes to the instrument specification data in the relatively specified risk-reversal market, the buy request, and the assembled creation templates, algorithms, components, data, etc. Associated newly created instruments, validation models, prioritization models, fill/execution models, miscellaneous rule models, components, date, etc., may be created, bound, and initialized, and readied for use.

In block 8.3.c.10, exchange server 104 optionally may identify an error (e.g., if the new limit books and associated algorithms, components, data, etc., cannot be created due to erroneous instrument specifications, missing data, and/or internal errors).

In block 8.2.e, exchange server 104 may, if an error is identified, send an application level reject (e.g., due to missing, malformed, and/or, erroneous information preventing execution of a trade for the relatively specified OTC FX Option Risk-Reversal; the new associated limit books, validation models, prioritization models, fill models, miscellaneous rule models, data, and components etc., for the new specifically specified instruments cannot be dynamically created and the requested trade cannot be completed, etc.). The exchange server 104 may record the reject message for state management, audit trail, and other future uses.

In block 8.3.c.11, exchange server 104 may, if no errors are identified, return the newly created limit books and associated algorithms, components and data.

In block 8.3.c.12, exchange server 104 may complete limit book configuration, binding and initialization of the newly created limit books and associated algorithms, components and data for use.

In block 8.3.c.13, exchange server 104 may complete binding of on-demand/real-time market data, reference data, rate term structures, volatility term structures, etc., and may ready them for use.

In block 8.3.c.14, exchange server 104 may complete binding of the newly created limit books to the exchange run-time environment and may ready them for immediate use.

In block 8.4.a, exchange server 104 may execute the requested buy trade against the relatively specified OTC FX Option Risk-Reversal posted market.

In block 8.4.b, exchange server 104 may validate the buy request using its validation models.

In block 8.4.c, exchange server 104 optionally may reject the buy request (e.g., due to validation rule violations).

With reference to FIG. 8F, in block 8.2.f, exchange server 104 may, if an error is identified, send an application level reject (e.g., due to missing, malformed, and/or, erroneous information preventing execution of a trade for the relatively specified OTC FX Option Risk-Reversal; the buy order instructions are invalid and the requested trade cannot be completed, etc.). The exchange server 104 may record the reject message for state management, audit trail, and other future uses.

In block 8.4.d, exchange server 104 may, if no errors are identified, execute the buy request according to its matching, prioritization and rule models. Trade executions may be created for some or all parties involved in the trade. The exchange server 104 may persist executed trade details for workflow management, auditing and other future uses. The fill process may continue until all executable offers have been consumed for the requested order type.

In block 8.4.e, exchange server 104 may generates execution reports for some or all parties.

In block 8.4.f, exchange server 104 may send the execution reports.

In block 8.4.g, exchange server 104 may send trade execution reports to some or all parties involved in the trade. Trade reports may be persisted for workflow management, auditing, and other future purposes.

In block 8.4.h, exchange server 104 may generate a new ‘last trade’ market data update.

In block 8.4.i, exchange server 104 may notify some or all clients with a previously registered interest of the update.

In block 8.4.j, exchange server 104 may send unsolicited new ‘last trade’ notification messages to some or all client terminals 102 with a previously registered interest in receiving new ‘last trade’ updates. For example, client terminals 102 may request a snapshot of currently defined ‘last trades’, and to receive ongoing unsolicited notification of all future ‘last trade’ updates. Client terminals 102 may cancel their ongoing interest in future ‘last trade’ updates at any time.

In block 8.5.a, exchange server 104 may post any residual quantity to the relatively specified OTC FX Option Risk-Reversal market as the new best-bid.

In block 8.5.b, exchange server 104 may validate the new market using its validation models.

In block 8.5.c, exchange server 104 optionally may reject the new market if, for example, it is determined to violate a validation rule.

In block 8.2.g, exchange server 104 may, if an error is identified, send an application level reject (e.g., due to missing, malformed, and/or, erroneous information preventing execution of a trade for the relatively specified OTC FX Option Risk-Reversal; the buy order instructions are invalid and the residual size cannot be posted, etc.). The exchange server 104 may record the reject message for state management, audit trail, and other future uses.

In block 8.5.d, exchange server 104 may post the new market according to its prioritization and rule models.

In block 8.5.e, exchange server 104 may post a new best bid for the relatively specified OTC FX Option Risk-Reversal market.

With reference to FIG. 8G, in block 8.5.f, exchange server 104 may determine that a new best-bid has been posted and the best offer has changed

In block 8.5.g, exchange server 104 may send unsolicited new best bid and offer notification messages to some or all client terminals 102 with a previously registered interest in receiving new best bid and/or offer updates. In an example, client terminals 102 may request a snapshot of currently defined best bids and offers, and to receive ongoing unsolicited notification of some or all future changes to the best bids and offers. Client terminals 102 may cancel their ongoing interest in future changes to the best bids and offers at any time.

In block 8.5.h, exchange server 104 may identify a change to its structure or depth of book for the relatively specified OTC FX Option Risk-Reversal market.

In block 8.5.i, exchange server 104 may book process changes to the books structure or depth of book.

In block 8.5.j, exchange server 104 may send unsolicited new depth of book notification messages to some or all client terminals 102 with a previously registered interest in receiving new depth of book updates. In an example, client terminals 102 may request a snapshot of current depth of books, and to receive ongoing unsolicited notification of some or all future changes to depth of books. Client terminals 102 may cancel their ongoing interest in future changes to depth of books at any time.

FIGS. 9A-E illustrate an example of requesting a new instrument limit book with dynamic instrument limit book creation in accordance with example embodiments. In this example, client terminal 102 may send a request 900 to create a new limit book for a previously unknown relatively specified OTC FX Option Strangle. The option strangle may be a multi-leg instrument where one buys or sells one call and one put at the same maturity but different strike with the same delta exposure. As a relatively specified instrument, the option maturities may be specified as tenors relative to the request date, and the strikes may be specified as deltas or ‘moneyness’ relative to the at-the-money or 0 delta. The new option strangle may be priced in terms of volatility.

To create this market and provide pre-trade price discovery to some or all connected client terminals, exchange server 104 may dynamically create a new strangle limit book. If the new limit book cannot be created, exchange server 104 may reject the request. Along with administrative details, the new limit book request may specify the desired new strangle instrument. In general, different instrument types may use different creation processes. In this example, exchange server 104 may create up to three new limit books: one for the call instrument if not currently defined, one for the put instrument if not currently defined, and one for the new strangle multi-leg instrument.

The creation process may manufacture new instruments along with quantitative pricing models and algorithms, limit books, fill models, validation models, prioritization models, rule models, components, data, bindings, etc., used for each new market. Once created, the new instruments, pricing models, and limit books may be bound to the exchange run-time environment, and connected client terminals may be notified of the newly created instruments and markets. The exchange then readies the new markets for use. Though described here for relatively specified OTC FX Option Strangles, this process applies to other instrument types including, for example, relatively specified instruments, specifically specified instruments, etc.

FIGS. 9B-E illustrate operations performed by a client terminal 102, and exchange process 902 and factory process 904 performed by exchange server 104. With reference to FIG. 9B, in block 9.1, client terminal 102 may submit a request to create a new market for a previously unknown relatively specified OTC FX Option Strangle. Along with system identifiers, time stamps, and content, the request may contain a full description of the new strangle instrument. Upon receipt, exchange server 104 may record receipt for state management, audit trail, and other future uses, and may invoke the defined handler process assigned to this request type. In this example, the assigned handler process may implement the dynamic instrument limit book creation process defined for the instrument type.

In block 9.2, exchange server 104 may validate structure and contents of the new relatively specified OTC FX Option Strangle request and acknowledge receipt by replying with an optional acceptance notification or a rejection notification due to errors. Validation may begin with basic system level checks for proper structure, identifiers, time stamps, common content, etc., and may continue throughout the dynamic instrument limit book creation process.

In block 9.2.a, exchange server 104 may acknowledge receipt of the new market request by replying with a system level acknowledgement message. The exchange server 104 may record the reject message for state management, audit trail, and other future uses.

In block 9.2.b, exchange server 104 optionally may acknowledge receipt of the new market request by replying with a system level reject due to, for example, errors in the structure or system level contents of the request (e.g., malformed structure, erroneous or missing identifiers, time stamps, content, etc.). The exchange server 104 may record the reject message for state management, audit trail, and other future uses.

In block 9.3, exchange server 104 may create a new market as the requested new relatively specified OTC FX Option Strangle market may not yet exist. The exchange server 104 may invoke the dynamic instrument limit book creation process to dynamically create, bind, initialize, and run all structures, components, processes, data, etc., used to price discover and trade the new relatively specified OTC FX Option Strangle market, including, but not limited to, instruments, pricing models, limit books, fill models, validation models, prioritization models, etc. The dynamic instrument limit book creation process may create as many markets as desired to define related markets. In an example, for the new strangle, the creation process may create up to three new markets: one for the call if not currently defined, one for the put if not currently defined, and one for the strangle multi-leg strategy. The process may begin with dynamic instrument creation.

In block 9.3.a.1, exchange server 104 may invoke the dynamic instrument creation process assigned to the requested instrument type (e.g., relatively specified OTC FX Option Strangle). In general, different instrument types may use different creation processes. Instrument creation processes may be predefined and run-time discoverable by instrument type. In general, the instrument creation process may use on-demand and/or continuous real-time pricing of related instruments, which may use discoverable static and real-time markets, reference data sources, rate term structures, volatility term structures, etc., along with associated quantitative algorithms and pricing models.

In block 9.3.a.2, exchange server 104 may retrieve instrument templates and associated components and data defined for the requested instrument type (e.g., relatively specified OTC FX Option Strangle), and may ready them for construction. These templates, components, and data may be predefined and run-time discoverable by instrument type. When combined with the instrument specification data contained in the request, they may be used to create, integrate, and bind the new instruments to the exchange run-time environment.

In block 9.3.a.3, exchange server 104 may retrieve instrument builder models and associated processes, components, and data, and may ready them for construction. These models, processes, components, and data may be predefined and run-time discoverable by instrument type.

In block 9.3.a.4, exchange server 104 may create new instruments by applying the builder models and processes to the instrument specification data in the request and the assembled templates and associated components, data, etc.

In block 9.3.a.5, exchange server 104 may persist the new instruments and associated components, data, etc., in its memory or other storage device (e.g., permanent store) for future reference and to manage their life cycles.

In block 9.3.a.6, exchange server 104 optionally may return an error, for example, if the new instruments and associated components, data, etc., cannot be created due to erroneous instrument specifications, missing data, and/or internal errors.

In block 9.2.c, exchange server 104 optionally may send an application level reject, for example, due to missing, malformed, and/or erroneous instrument specifications for the new relatively specified OTC FX Option Strangle; the new associated instruments, data, and components etc., cannot be dynamically created. The exchange server 104 may record the reject message for state management, audit trail, and other future uses.

In block 9.3.a.7, exchange server 104 may, if no errors are identified, return newly created relatively specified OTC FX Option Strangle instruments and associated components and data.

In block 9.3.a.8, exchange server 104 may complete configuration, binding and initialization of the newly created relatively specified FX Option Strangle instruments and associated components, data, etc., and may ready them for use.

With reference to FIG. 9C, in block 9.3.a.9, exchange server 104 may send unsolicited new instrument creation messages for the newly created relatively specified OTC FX Option Strangle instruments to some or all client terminals with a previously registered interest in receiving new instrument updates. For example, client terminals 102 may request a snapshot of currently defined instruments and may request ongoing unsolicited notification of some or all instruments created in the future. Client terminals 102 may cancel their ongoing interest in future instrument creation updates at any time.

In block 9.3.b.1, exchange server 104 may invoke dynamic pricing model creation processes assigned to the requested instrument type (e.g., relatively specified OTC FX Option Strangle). In general, different instrument types may use different creation processes for associated pricing models, algorithms, components, data, etc. These creation processes may be predefined and run-time discoverable. The pricing model process may use on demand or continuous real-time pricing of related instruments, which may use run-time discoverable associated static and real-time markets, reference data sources, rate term structures, volatility term structures, etc., and associated quantitative algorithms and pricing models. The pricing model creation process may create as many pricing model and associated algorithms, and data bindings such that related instruments are on-demand/real-time price-able. In an example, for the new strangle, the creation process may create up to three new sets of pricing models: one for the call if not currently defined, one for the put if not currently defined, and one for the strangle multi-leg strategy.

In block 9.3.b.2, exchange server 104 may retrieve model templates and associated algorithms, components and data defined for the requested instrument type, relatively specified OTC FX Option Strangle, and may ready them for construction. These templates, algorithms, components, and data may be predefined and run-time discoverable by instrument type. When combined with the specification data contained in the request, they may be used to create, integrate, and bind the new pricing models and algorithms to the exchange run-time environment.

In block 9.3.b.3, exchange server 104 may retrieve associated static/real-time market data, reference data, rate term structures, volatility term structures, and other related data bindings and templates, and may ready them for construction. These bindings, templates, and data may be predefined and run-time discoverable by instrument type.

In block 9.3.b.4, exchange server 104 may retrieve pricing model builder models and associated processes, components, and data, and may ready them for construction. These builder models, processes, components, and data may be predefined and run-time discoverable by instrument type.

In block 9.3.b.5, exchange server 104 may create new pricing models by applying the builder models and processes to the instrument specification data in the request and the assembled creation templates and associated algorithms, components, data, etc.

In block 9.3.b.6, exchange server 104 optionally may return an error if, for example, the new pricing models and associated algorithms, components, data, etc., cannot be created due to erroneous instrument specifications, missing data, and/or internal errors.

In block 9.2.d, exchange server 104 may, if an error is identified, send an application level reject (e.g., due to missing, malformed, and/or, erroneous instrument specifications for the new OTC FX Option Strangle; the new associated pricing models, algorithms, data, and components, etc., cannot be dynamically created). The exchange server 104 may record the reject message for state management, audit trail, and other future uses.

In block 9.3.b.7, exchange server 104 may return the newly created pricing models and associated algorithms, components and data.

In block 9.3.b.8, exchange server 104 may complete pricing model configuration, binding and initialization of the newly created pricing models and associated algorithms, components, data, etc., and may ready them for use.

In block 9.3.b.9, exchange server 104 may complete configuration and initialization of the market data, reference data, rate term structures, volatility term structures, etc., bind the newly created pricing models and associated algorithms, components, data, etc., and may ready them for use.

In block 9.3.b.10, exchange server 104 may bind the newly created pricing models and associated algorithms to the exchange real-time pricing environment and begin pricing the newly created instruments.

With reference to FIG. 9D, in block 9.3.c.1, exchange server 104 may invoke a dynamic limit book creation process assigned to the requested instrument type (e.g., relatively specified OTF FX Option Strangle). In general, different instrument types may use different creation processes for associated limit books, validation models, prioritization models, fill models, miscellaneous rule models, etc. These creation processes may be predefined and run-time discoverable. The limit book creation process may use on demand or continuous real-time pricing of associated instruments, which may use run-time discoverable on-demand and real-time markets, reference data sources, rate term structures, volatility term structures, etc., and associated quantitative algorithms and pricing models. The limit book creation process may create as many limit books and associated fill models, validation models, prioritization models, rule models, and data bindings so that related instruments are real-time price discoverable and tradable. In an example, for the new strangle, the creation process may create up to three new sets of limit books: one for the call if not currently defined, one for the put if not currently defined, and one for the strangle multi-leg strategy.

In block 9.3.c.2, exchange server 104 may retrieve limit book model templates and associated algorithms, components and data defined for the requested instrument type (e.g., relatively specified OTC FX Option Strangle), and may ready them for construction. These model templates, algorithms, components, and data may be predefined and run-time discoverable by instrument type. When combined with the specification data contained in the request, they may be used to create, integrate, and bind the limit book models into the exchange run-time environment.

In block 9.3.c.3, exchange server 104 may retrieve associated validation model templates and associated algorithms, components, and data, and may ready them for construction. These validation model templates, components, and data may be predefined and run-time discoverable by instrument type.

In block 9.3.c.4, exchange server 104 may retrieve associated prioritization model templates and associated algorithms, components, and data, and may ready them for construction. These prioritization model templates, components, and data may be predefined and run-time discoverable by instrument type.

In block 9.3.c.5, exchange server 104 may retrieve associated fill/execution model templates and associated algorithms, components, and data, and may ready them for construction. These fill/execution model templates, components, and data may be cached or predefined and discoverable by instrument type.

In block 9.3.c.6, exchange server 104 may retrieve other associated rule model templates, algorithms, components, and data, and readies them for construction. These rule models templates, algorithms, components, and data may be predefined and run-time discoverable by instrument type.

In block 9.3.c.7, exchange server 104 may retrieve associated bindings for associated on-demand/real-time market data, reference data, rate term structures, volatility term structures, and other related data and may ready them for construction. These bindings and data may be predefined and run-time discoverable by instrument type.

In block 9.3.c.8, exchange server 104 may retrieve limit book builder models and associated processes, components, and data, and may ready them for construction. These builder models, processes, components, and data may be predefined and run-time discoverable by instrument type.

In block 9.3.c.9, exchange server 104 may create new limit books by applying the builder models and processes to the instrument specification data in the request and the assembled creation templates, algorithms, components, data, etc. Associated newly created instruments, validation models, prioritization models, fill/execution models, miscellaneous rule models, components, date, etc., may be created, bound, and initialized, and readied for use.

In block 9.3.c.10, exchange server 104 optionally may return an error if, for example, the new limit books and associated algorithms, components, data, etc., cannot be created due to erroneous instrument specifications, missing data, and/or internal errors.

In block 9.2.e, exchange server 104 may, if an error is identified, send an application level reject (e.g., due to missing, malformed, and/or, erroneous instrument specifications for the new OTC FX Option Straddle; the new associated limit books, validation models, prioritization models, fill models, miscellaneous rule models, data, and components, etc., cannot be dynamically created). The exchange server 104 may record the reject message for state management, audit trail, and other future uses.

In block 9.3.c.11, exchange server 104 may return the newly created limit books and associated algorithms, components and data.

In block 9.3.c.12, exchange server 104 may complete limit book configuration, binding and initialization of the newly created limit books and associated algorithms, components and data for use.

With reference to FIG. 9E, in block 9.3.c.13, exchange server 104 may complete final binding of on-demand/real-time market data, reference data, rate term structures, volatility term structures, etc., and may ready them for use.

In block 9.3.c.14, exchange server 104 may complete binding of the newly created limit books to the exchange run-time environment and may ready them for immediate use.

FIGS. 10A-G depict an example of executing a generic trade request with dynamic instrument limit book creation in accordance with example embodiments. In this example, client terminal 102 may send a buy order request 1000 to trade against a previously posted offer price and quantity for a relatively specified generic OTC Instrument. The generic OTC Instrument may be of any asset class and of any type (e.g., underlying, simple derivative, exotic derivative, multi-leg strategy, etc.). As a relatively specified instrument, the defining attributes may be specified in relative terms. For example, maturities may be specified as tenors relative to the request date, strikes may be specified as deltas or ‘moneyness’ relative to the at-the-money or 0 delta, etc. The generic OTC Instrument may be priced in terms of volatility, volatility spreads, etc.

Trade execution of relatively specified instrument types may generate the agreed upon specifically specified instruments at the time of the trade, the specifics and associated prices being defined by rules, market conventions, and negotiation between parties. Consequently, to execute the requested trade, exchange server 104 may dynamically create specifically specified markets associated with the trade, record and report trade details to both parties, and distribute new specific trade prices/quantities. Additionally, for a relatively specified OTC Instrument, exchange server 104 may record and report trade details and distribute changes to top-of-book. If the requested markets cannot be created, exchange server 104 may reject the request. Any residual un-executed quantity that can post a new bid/offer may follow the “Post New Market” process described above.

In some examples, different instrument types may use different instrument limit book creation processes. For each instrument type, exchange server 104 may create as many new limit books as needed to comply with the instrument specification. The creation process may manufacture new instruments along with quantitative pricing models and algorithms, limit books, fill models, validation models, prioritization models, rule models, components, data, bindings, etc., used by each new market. Once created, the new instruments, pricing models, and limit books may be bound to the exchange run-time environment, and connected client terminals may be notified of the newly created instruments and markets. The exchange server 104 may then ready the new markets for immediate use. Though described here for specifically specified OTC instruments, this process applies equivalently to other instrument types, including, for example, relatively specified instruments, specifically specified instruments, etc.

FIGS. 10B-G illustrate operations performed by a client terminal 102, and exchange process 1002 and relative risk-reversal limit book process 1004 performed by exchange server 104. With reference to FIG. 10B, in block 10.1, client terminal 102 may submit, for example, a request to buy 5,000,000 of a relatively specified OTC Instrument at a previously posted offer price of 2 (market convention units). As a limit buy order good for the day, any unfilled residual size may be posted at the limit price of 2. The request may contain any additional information used for calculating the specifically specified instruments generated by the trade. Upon receipt, exchange server 104 may record receipt for state management, audit trail, and other future uses, and may invoke a defined handler process assigned to this request type. In this example, the assigned handler process may implement a fill process for day limit orders, a posting process, and a dynamic instrument limit book creation process defined for this instrument type.

In block 10.2, exchange server 104 may validate structure and contents of the relatively specified OTC Instrument buy request and acknowledge receipt by replying with an optional acceptance notification or a rejection notification due to errors. Validation may begin with basic system level checks for proper structure, identifiers, time stamps, common content, etc., and may continue throughout the fill, posting, and dynamic instrument limit book creation processes.

In block 10.2.a, exchange server 104 may acknowledge receipt of the buy request by replying with a system level acknowledgement message. The exchange server 104 may record the reject message for state management, audit trail, and other future uses.

In block 10.2.b, exchange server 104 optionally may acknowledge receipt of the buy request by replying with a system level reject due to, for example, errors in the structure or system level contents of the request (e.g., malformed structure, erroneous or missing identifiers, time stamps, content, etc.). The exchange server 104 may record the reject message for state management, audit trail, and other future uses.

In block 10.3, exchange server 104 may execute, for example, the request to buy 5,000,000 of the relatively specified OTC Instrument, if an executable market exists, and post any unfilled residual quantity. The fill process may create specifically specified instruments to complete the trades. Accordingly, exchange server 104 may invoke a dynamic instrument limit book creation process to dynamically create, bind, initialize, and run structures, components, processes, data, etc., to price discover and trade the new specifically specified OTC Instrument market, including, but not limited to, instruments, pricing models, limit books, fill models, validation models, prioritization models, etc. The dynamic instrument limit book creation process may create as many markets as desired to define related markets. The process may begin with dynamic instrument creation.

In block 10.3.a.1, exchange server 104 may invoke dynamic instrument creation process assigned to the fill instrument type (e.g., specifically specified OTC Instrument). Different instrument types may use different creation processes. Instrument creation processes may be predefined and run-time discoverable by instrument type. In general, the instrument creation process may use on-demand and/or continuous real-time pricing of related instruments, which may use discoverable static and real-time markets, reference data sources, rate term structures, volatility term structures, etc., along with associated quantitative algorithms and pricing models. The instrument creation process may create as many instruments as desired to define related instruments.

In block 10.3.a.2, exchange server 104 may retrieve instrument templates and associated components and data defined for the fill instrument type (e.g., specifically specified OTC Instrument), and may ready them for construction. These templates, components, and data may be predefined and run-time discoverable by instrument type. When combined with the instrument specification data contained in the relatively specified buy request, they may be used to create, integrate, and bind the new instruments to the exchange run-time environment.

In block 10.3.a.3, exchange server 104 may retrieve instrument builder models and associated processes, components, and data, and may ready them for construction. These models, processes, components, and data may be predefined and run-time discoverable by instrument type.

In block 10.3.a.4, exchange server 104 may create new instruments by applying the builder models and processes to the instrument specification data in the request and the assembled templates and associated components, data, etc.

In block 10.3.a.5, exchange server 104 may persist the new instruments and associated components, data, etc., in memory or other storage device (e.g., its permanent store) for future reference and to manage their life cycles.

In block 10.3.a.6, exchange server 104 optionally may return an error if, for example, the new instruments and associated components, data, etc., cannot be created due to erroneous instrument specifications, missing data, and/or internal errors.

In block 10.2.c, exchange server 104 may send an application level reject (e.g., due to missing, malformed, and/or erroneous information preventing execution of a trade for the relatively specified OTC Instrument; the new associated specifically specified instruments, data, and components etc., cannot be dynamically created and the requested trade cannot be completed). The exchange server 104 may record the reject message for state management, audit trail, and other future uses.

With reference to FIG. 10C, in block 10.3.a.7, exchange server 104 may, if no errors are identified, return the newly created specifically specified OTC Instruments and associated components and data.

In block 10.3.a.8, exchange server 104 may complete configuration, binding and initialization of the newly created specifically specified OTC Instruments and associated components, data, etc., and may ready them for use.

In block 10.3.a.9, exchange server 104 may send unsolicited new instrument creation messages for newly created specifically specified OTC instruments to some or all client terminals with a previously registered interest in receiving new instrument updates. For example, client terminals may request a snapshot of currently defined instruments and to receive ongoing unsolicited notification of some or all instruments created in the future. Client terminals may cancel their ongoing interest in future instrument creation updates at any time.

In block 10.3.b.1, exchange server 104 may invoke dynamic pricing model creation processes assigned to the fill instrument type (e.g., specifically specified OTC Instrument). Different instrument types may use different creation processes for associated pricing models, algorithms, components, data, etc. These creation processes may be predefined and run-time discoverable. The pricing model process may use on demand or continuous real-time pricing of related instruments, which may use run-time discoverable associated static and real-time markets, reference data sources, rate term structures, volatility term structures, etc., and associated quantitative algorithms and pricing models. The pricing model creation process may create as many pricing models and associated algorithms, and data bindings as desired so that related instruments are on-demand/real-time price-able.

In block 10.3.b.2, exchange server 104 may retrieve model templates and associated algorithms, components and data defined for the fill instrument type (e.g., specifically specified OTC Instrument), and may ready them for construction. These templates, algorithms, components, and data may be predefined and run-time discoverable by instrument type. When combined with the specification data contained in the request, they may be used to create, integrate, and bind the new pricing models and algorithms to the exchange run-time environment.

In block 10.3.b.3, exchange server 104 may retrieve associated static/real-time market data, reference data, rate term structures, volatility term structures, and other related data bindings and templates, and may ready them for construction. These bindings, templates, and data are predefined and run-time discoverable by instrument type.

In block 10.3.b.4, exchange server 104 may retrieve pricing model builder models and associated processes, components, and data, and may ready them for construction. These builder models, processes, components, and data may be predefined and run-time discoverable by instrument type.

In block 10.3.b.5, exchange server 104 may create new pricing models by applying the builder models and processes to the instrument specification data in the request and the assembled creation templates and associated algorithms, components, data, etc.

In block 10.3.b.6, exchange server 104 optionally may return an error if, for example, the new pricing models and associated algorithms, components, data, etc., cannot be created due to erroneous instrument specifications, missing data, and/or internal errors.

With reference to FIG. 10D, in block 10.2.d, exchange server 104 may send an application level reject (e.g., due to missing, malformed, and/or, erroneous information preventing execution of a trade for the relatively specified OTC instrument; the new associated pricing models, algorithms, data, and components etc., for the new specifically specified instruments cannot be dynamically created and the requested trade cannot be completed, etc.). The exchange server 104 may record the reject message for state management, audit trail, and other future uses.

In block 10.3.b.7, exchange server 104 may return the newly created pricing models and associated algorithms, components and data.

In block 10.3.b.8, exchange server 104 may complete pricing model configuration, binding and initialization of the newly created pricing models and associated algorithms, components, data, etc., and may ready them for use.

In block 10.3.b.9, exchange server 104 may complete configuration and initialization of the market data, reference data, rate term structures, volatility term structures, etc., bind the newly created pricing models and associated algorithms, components, data, etc., and may ready them for use.

In block 10.3.b.10, exchange server 104 may bind the newly created pricing models and associated algorithms to the exchange real-time pricing environment and begin pricing newly created instruments.

In block 10.3.c.1, exchange server 104 may invoke a dynamic limit book creation process assigned to the fill instrument type (e.g., specifically specified OTC Instrument). In general, different instrument types may use different creation processes for associated limit books, validation models, prioritization models, fill models, miscellaneous rule models, etc. These creation processes may be predefined and run-time discoverable. The limit book creation process may use on demand or continuous real-time pricing of associated instruments, which may use run-time discoverable on-demand and real-time markets, reference data sources, rate term structures, volatility term structures, etc., and associated quantitative algorithms and pricing models. The limit book creation process may create as many limit books and associated fill models, validation models, prioritization models, rule models, and data bindings so that related instruments are real-time price discoverable and tradable.

In block 10.3.c.2, exchange server 104 may retrieve limit book model templates and associated algorithms, components and data defined for the fill instrument type (e.g., specifically specified OTC Instrument), and may ready them for construction. These model templates, algorithms, components, and data may be predefined and run-time discoverable by instrument type. When combined with the specification data contained in the request, they may be used to create, integrate, and bind the limit book models into the exchange run-time environment.

In block 10.3.c.3, exchange server 104 may retrieve associated validation model templates and associated algorithms, components, and data, and may ready them for construction. These validation model templates, components, and data may be predefined and run-time discoverable by instrument type.

In block 10.3.c.4, exchange server 104 may retrieve associated prioritization model templates and associated algorithms, components, and data, and may ready them for construction. These prioritization model templates, components, and data may be predefined and run-time discoverable by instrument type.

In block 10.3.c.5, exchange server 104 may retrieve associated fill/execution model templates and associated algorithms, components, and data, and may ready them for construction. These fill/execution model templates, components, and data may be cached or predefined and discoverable by instrument type.

In block 10.3.c.6, exchange server 104 may retrieve other associated rule model templates, algorithms, components, and data, and may ready them for construction. These rule models templates, algorithms, components, and data may be predefined and run-time discoverable by instrument type.

In block 10.3.c.7, exchange server 104 may retrieve associated bindings for associated on-demand/real-time market data, reference data, rate term structures, volatility term structures, and other related data and may ready them for construction. These bindings and data may be predefined and run-time discoverable by instrument type.

With reference to FIG. 10E, in block 10.3.c.8, exchange server 104 may retrieve limit book builder models and associated processes, components, and data, and may ready them for construction. These builder models, processes, components, and data may be predefined and run-time discoverable by instrument type.

In block 10.3.c.9, exchange server 104 may create new limit books by applying the builder models and processes to the instrument specification data in the relatively specified instrument, the buy request, and the assembled creation templates, algorithms, components, data, etc. Associated newly created instruments, validation models, prioritization models, fill/execution models, miscellaneous rule models, components, date, etc., may be created, bound, and initialized, and readied for use.

In block 10.3.c.10, exchange server 104 optionally may return an error if, for example, the new limit books and associated algorithms, components, data, etc., cannot be created due to erroneous instrument specifications, missing data, and/or internal errors.

In block 10.2.e, exchange server 104 may send an application level reject (e.g., due to missing, malformed, and/or, erroneous information preventing execution of a trade for the relatively specified OTC instrument; the new associated limit books, validation models, prioritization models, fill models, miscellaneous rule models, data, and components etc., for the new specifically specified instruments cannot be dynamically created and the requested trade cannot be completed, etc.). The exchange server 104 may record the reject message for state management, audit trail, and other future uses.

In block 10.3.c.11, exchange server 104 may return the newly created limit books and associated algorithms, components and data.

In block 10.3.c.12, exchange server 104 may complete limit book configuration, binding and initialization of the newly created limit books and associated algorithms, components and data for use.

In block 10.3.c.13, exchange server 104 may complete binding of on-demand/real-time market data, reference data, rate term structures, volatility term structures, etc., and may ready them for immediate use.

In block 10.3.c.14, exchange server 104 may complete binding of the newly created limit books to the exchange run-time environment and may ready them for use.

In block 10.4.a, exchange server 104 may execute the requested buy trade against the relatively specified OTC Instrument posted market.

In block 10.4.b, exchange server 104 may validate the buy request using its validation models.

In block 10.4.c exchange server 104 optionally may reject the buy request, for example, due to validation rule violations.

With reference to FIG. 10F, in block 10.2.f, exchange server 104 may send an application level reject (e.g., due to missing, malformed, and/or, erroneous information preventing execution of a trade for the relatively specified OTC Instrument; the buy order instructions are invalid and the requested trade cannot be completed, etc.). The exchange server 104 may record the reject message for state management, audit trail, and other future uses.

In block 10.4.d, exchange server 104 may execute the buy request according to its matching, prioritization and rule models. Trade executions may be created for some or all parties involved in the trade. Exchange server 104 may persist some or all executed trade details for workflow management, auditing and other future uses. The fill process may continue until some or all executable offers have been consumed for the requested order type.

In block 10.4.e, exchange server 104 may generate trade execution reports for some or all parties.

In block 10.4.f, exchange server 104 may process the execution reports and, in block 10.4.g, may send the execution reports to some or all parties involved in the trade. The trade execution reports may be persisted for workflow management, auditing, and other future purposes.

In block 10.4.h, exchange server 104 may generate a new ‘last trade’ market data update. In block 10.4.i, exchange server 104 may process the new ‘last trade’ market data update and may notify some or all client terminals with a previously registered interest.

In blocks 10.4.i and 10.4.j, exchange server 104 may send unsolicited new ‘last trade’ notification messages to some or all client terminals with a previously registered interest in receiving new ‘last trade’ updates. For example, client terminals may request a snapshot of currently defined ‘last trades’, and to receive ongoing unsolicited notification of some or all future ‘last trade’ updates. Client terminals may cancel their ongoing interest in future ‘last trade’ updates at any time.

In block 10.5.a, exchange server 104 post any residual quantity to the relatively specified OTC Instrument market as the new best-bid.

In block 10.5.b, exchange server 104 may validate the new market using its validation models.

In block 10.5.c, exchange server 104 optionally may reject the new market due to, for example, validation rule violations.

In block 10.2.g, exchange server 104 may send an application level reject (e.g., due to missing, malformed, and/or, erroneous information preventing execution of a trade for the relatively specified OTC Instrument; the buy order instructions are invalid and the residual size cannot be posted, etc.). The exchange server 104 may record the reject message for state management, audit trail, and other future uses.

In block 10.5.d, exchange server 104 may post the new market according to its prioritization and rule models.

In block 10.5.e, exchange server 104 may post a new best bid for the relatively specified OTC Instrument market.

With reference to FIG. 10G, in block 10.5.f, exchange server 104 may determine that a new best-bid has been posted and the best-offer has changed. In turn, exchange server 104 may notify some or all clients with a previously registered interest.

In block 10.5.g, exchange server 104 may send unsolicited new best bid and offer notification messages to some or all client terminals with a previously registered interest in receiving new best bid and/or offer updates. For example, client terminals may request a snapshot of currently defined best bids and offers, and to receive ongoing unsolicited notification of all future changes to the best bids and offers. Client terminals may cancel their ongoing interest in future changes to the best bids and offers at any time.

In block 10.5.h, exchange server 104 may post a change to its structure or depth of book for the relatively specified OTC FX Option Risk-Reversal market.

In block 10.5.i, exchange server 104 may identify changes to the books structure or depth of book. In turn, exchange server 104 may notify some or all clients with a previously registered interest.

In block 10.5.j, exchange server 104 may send unsolicited new best-bid-offer and depth-of-book notification messages to some or all client terminals with a previously registered interest in receiving new best-bid-offer and/or depth-of-book updates. For example, client terminals may request a snapshot of current best-bid-offers and/or depth-of-books, and to receive ongoing unsolicited notification of all future changes. Client terminals may cancel their ongoing interest in future changes at any time.

The various devices, participants, and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, system 100 and the methods described herein may be configured to provide dynamic market creation. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations.

1. A computer-implemented method comprising:
receiving a new market request that requests creation of a market for trading of a new financial instrument, wherein the request identifies an instrument type, quantity, and price;
in response to the request, creating, by a processor, a financial instrument based on the instrument type, the quantity, and the price;
creating, by the processor, a pricing model, a limit book, and a fill model for the created financial instrument;
initializing and binding the created financial instrument, the limit book, the pricing model, and the fill model; and
activating, by the processor, the limit book for price discovery and trading of the created financial instrument.

2. The method of claim 1, further comprising publishing a new limit book notification for informing other traders about the created financial instrument.

3. The method of claim 1, wherein creating of the financial instrument further comprises:
retrieving instrument data and resources;
retrieving instrument builder models;
constructing the financial instrument based on the instrument data, the resources, and the instrument builder models;
binding the instrument data and the resources to the financial instrument; and
persisting the financial instrument and binding to an exchange real-time environment.

4. The method according to claim 1, wherein creating of the pricing model further comprises:
retrieving pricing model data and resources;
retrieving pricing model builder models;
constructing the pricing model based on the pricing model, the resources, and the pricing model builder models;
binding the pricing model data and the resources to the pricing model; and
persisting the pricing model and binding to an exchange real-time environment.

5. The method according to claim 1, wherein creating of the limit book further comprises:
retrieving limit book data and resources;
retrieving limit book builder models;
constructing the limit book based on the limit book data, the resources, and the limit book builder models;
binding the limit book data and the resources to the limit book; and
persisting the limit book and binding to an exchange real-time environment.

6. The method according to claim 1, wherein creating of the fill model further comprises:
retrieving fill model data and resources;
retrieving fill model builder models;
constructing the fill model based on the fill model data, the resources, and the fill model builder models;
binding the fill model data and the resources to the fill model; and
persisting the fill model and binding to an exchange real-time environment.

7. The method of claim 1, wherein the new market request further comprises an identifier and data for each of a plurality of leg instruments.

8. An apparatus comprising:
means for receiving a new market request that requests creation of a market for trading of a new financial instrument, wherein the request identifies an instrument type, quantity, and price;
means for creating, in response to the request, a financial instrument based on the instrument type, the quantity, and the price;
means for creating a pricing model, a limit book, and a fill model for the created financial instrument;
means for initializing and binding the created financial instrument, the limit book, the pricing model, and the fill model; and
means for activating the limit book for price discovery and trading of the created financial instrument.

9. The apparatus of claim 8, further comprising means for publishing a new limit book notification for informing other traders about the created financial instrument.

10. The apparatus of claim 8, wherein the means for creating of the financial instrument further comprises:
means for retrieving instrument data and resources;
means for retrieving instrument builder models;
means for constructing the financial instrument based on the instrument data, the resources, and the instrument builder models;
means for binding the instrument data and the resources to the financial instrument; and
means for persisting the financial instrument and binding to an exchange real-time environment.

11. The apparatus according to claim 8, wherein the means for creating of the pricing model further comprises:
means for retrieving pricing model data and resources;
means for retrieving pricing model builder models;
means for constructing the pricing model based on the pricing model, the resources, and the pricing model builder models;
means for binding the pricing model data and the resources to the pricing model; and
means for persisting the pricing model and binding to an exchange real-time environment.

12. The apparatus according to claim 8, wherein the means for creating of the limit book further comprises:
means for retrieving limit book data and resources;
means for retrieving limit book builder models;
means for constructing the limit book based on the limit book data, the resources, and the limit book builder models;
means for binding the limit book data and the resources to the limit book; and
means for persisting the limit book and binding to an exchange real-time environment.

13. The apparatus according to claim 8, wherein the means for creating of the fill model further comprises:
means for retrieving fill model data and resources;
means for retrieving fill model builder models;
means for constructing the fill model based on the fill model data, the resources, and the fill model builder models;
means for binding the fill model data and the resources to the fill model; and
means for persisting the fill model and binding to an exchange real-time environment.

14. The apparatus of claim 8, wherein the new market request further comprises an identifier and data for each of a plurality of leg instruments.

15. A non-transitory computer readable medium storing instructions that, when executed, cause an apparatus at least to perform:
receiving a new market request that requests creation of a market for trading of a new financial instrument, wherein the request identifies an instrument type, quantity, and price;
in response to the request, creating a financial instrument based on the instrument type, the quantity, and the price;
creating a pricing model, a limit book, and a fill model for the created financial instrument;
initializing and binding the created financial instrument, the limit book, the pricing model, and the fill model; and
activating the limit book for price discovery and trading of the created financial instrument.

16. The computer readable medium of claim 15, further comprising publishing a new limit book notification for informing other traders about the created financial instrument.

17. The computer readable medium of claim 15, wherein creating of the financial instrument further comprises:
retrieving instrument data and resources;
retrieving instrument builder models;
constructing the financial instrument based on the instrument data, the resources, and the instrument builder models;
binding the instrument data and the resources to the financial instrument; and
persisting the financial instrument and binding to an exchange real-time environment.

18. The computer readable medium according to claim 15, wherein creating of the pricing model further comprises:
retrieving pricing model data and resources;
retrieving pricing model builder models;
constructing the pricing model based on the pricing model, the resources, and the pricing model builder models;
binding the pricing model data and the resources to the pricing model; and
persisting the pricing model and binding to an exchange real-time environment.

19. The computer readable medium according to claim 15, wherein creating of the limit book further comprises:
retrieving limit book data and resources;
retrieving limit book builder models;
constructing the limit book based on the limit book data, the resources, and the limit book builder models;
binding the limit book data and the resources to the limit book; and
persisting the limit book and binding to an exchange real-time environment.

20. The computer readable medium according to claim 15, wherein creating of the fill model further comprises:
retrieving fill model data and resources;
retrieving fill model builder models;
constructing the fill model based on the fill model data, the resources, and the fill model builder models;
binding the fill model data and the resources to the fill model; and
persisting the fill model and binding to an exchange real-time environment.
